(19) United States
(12) Patent Application Publication
(10) Pub. No.: US 2016/0065846 A1
(43) Pub. Date: Mar. 3, 2016

(54) Method And System Of Transmitting Images Over The Internet

(71) Applicant: Angelbook LLC, Salem, OH (US)

(72) Inventors: Kenneth H. Cathcart, Lehighton, PA (US); Daniel C. Cresap, Smithville, MS (US); Joseph J. Korff, Riviera Beach, FL (US)

(21) Appl. No.: 14/938,893

(22) Filed: Nov. 12, 2015

Related U.S. Application Data
(63) Continuation-in-part of application No. 13/788,219, filed on Mar. 7, 2013, now abandoned.
(60) Provisional application No. 61/608,236, filed on Mar. 8, 2012.

(51) Int. Cl. H04N 5/232; H04N 1/00

(52) U.S. Cl. CPC H04N 5/23222; H04N 1/00244

(57) ABSTRACT

A system for remotely perceiving and transmitting images and sounds associated with a target object includes a power source, a camera (optionally with a microphone), a television or video screen, at least one speaker, a computer, a website, an internet connection, and a power source.

### TECHNICAL FIELD

A method and system of transmitting images and/or sounds of a target object or an environment to a user over a computer network is disclosed. The user may control certain aspects of the viewing/listening experience.

### BACKGROUND

A system for transmitting sounds and images related to an object or environment together with a messaging system capable of posting commentary about the object or environment, all optionally carried out over a computer network, such as over the internet, is heretofore unknown.

### SUMMARY OF THE INVENTION

The invention relates to a system for perceiving and transmitting images and sounds and sharing information associated with a target object or environment, comprising: (a) a power source, (b) a camera (optionally including a microphone), (c) a television or video screen, (d) at least one speaker, (e) a computer, (f) a website, and (g) an internet connection.

### DETAILED DESCRIPTION OF THE INVENTION

The invention relates to a system for remotely perceiving images and sounds from any desired location, comprising: (a) a power source, (b) a camera (optionally including a microphone), (c) a television or video screen, (d) at least one speaker, (e) a computer, (f) a website, and (g) an internet connection.

The invention further relates to a system for perceiving and transmitting images and sounds and sharing information associated with a target object or environment, comprising: (a) a power source, (b) a camera, (c) a speaker, (d) a computer, (e) a video screen, (f) a database, (g) a website, and (h) an internet connection,

wherein the power source, speaker, at least part of the internet connection and camera, are operatively connected together proximate the target object or environment,

wherein the computer, video screen, database, website and camera are operatively connected to form an operative connection, such that commands entered into the computer are transmitted through the internet connection to effect control of the camera, and

wherein the database is capable of storing data perceived by the camera and transmitted to it through at least one of the website and internet connection to the computer.

An embodiment of the invention is a method of presenting at least one of images and sounds of a person comprising: (a) recording at least one of images and sounds of a person, (b) storing the at least one of images and sounds on a server accessible to the internet, (c) providing and operatively connecting together a power source, at least one of a speaker and a video screen, and wireless internet transceiver proximate a gravestone, the power source including (i) a solar panel, and (ii) a least one of a battery and a mains power source, (d) providing a control switch by which a user may control the playback of at least one of a speaker and video screen, (e) providing a website, to which the computer, at least one of a speaker and a video screen and a computer are operatively connected, and (f) operating (1) the control switch or (2) the website to command the server to play back the at least one of images and sounds either on the computer screen or on the at least one of speaker and video screen proximate the gravestone.

The power source may be any power source however is typically selected from the group consisting of a solar panel, a battery, a mains power source, a fuel cell, a galvanic power source, and any other external power source. The galvanic power may be a derived from a circuit including the housing, camera hardware, and the ground on which the housing is mounted. The battery may be a primary battery (non-rechargeable) or a secondary battery (rechargeable) battery. A solar panel may be any type commercially available or any type constructed by a user. Useful solar panels typically include solar cells based on silicon. A mains power source may depend on the country in which the system is set up, for example 110 volts, 60 cycles in the United States and 220 volts and 50 cycles in Europe and other countries. Three cycle power is envisioned as well.

The internet connection bay be or involve at least one selected from the group consisting of telephone modem, DSL, GSM, WiFi, wireless internet, cellular phone, T1 line, cable internet, satellite, and combinations thereof.

The several components set forth hereinabove may be protected from weather and solar radiation by a housing. The housing may at least partially contain at least any or all of the components of the system such as for example, the camera, power source, a computer, and portions of the apparatus necessary to secure an internet connection such as wiring, a modem, and/or a Wi-Fi transceiver. The aforementioned components are typically operatively connected to one another within or near the housing. The housing may have the appearance of a footstone similar to the appearance of a gravestone nearby or of any desired object or environment The housing may be hermetically sealed. The footstone may be weatherproof and may be anchored securely to the ground or other foundation. The footstone may be of any construction such as glass, ceramic, stone, concrete, wood, metal, polymer, and plastic, including injection molded plastic or plastic shaped by three-dimensional (3D) printing. Combinations of the foregoing are also envisioned. Sealants such as caulks or silicones may be used to adhere components of the housing to a footstone or otherwise to protect the contents from effects of weather or solar radiation.

The system includes a website, housed on a computer that is usually remotely located from the camera and power source as well as remotely from, but accessible by, the computer. The website may provide a virtual storefront on which tangible items and services can be purchased. The website may also include a user interface protected by at least a username and password that allows access to features inaccessible to a user that does not have the username and password. Obtaining a username and password may be contingent on the payment of a fee, either one time or periodic. Such features include message boards for posting certain categories of messages, for example, memorials to deceased persons or the creation of a family tree.

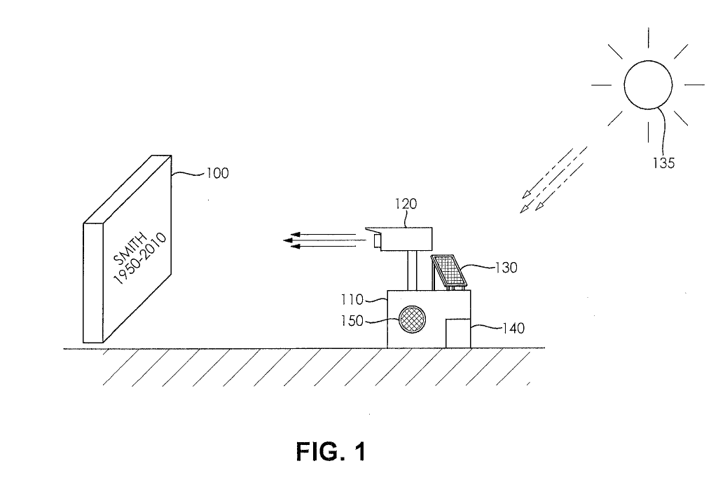

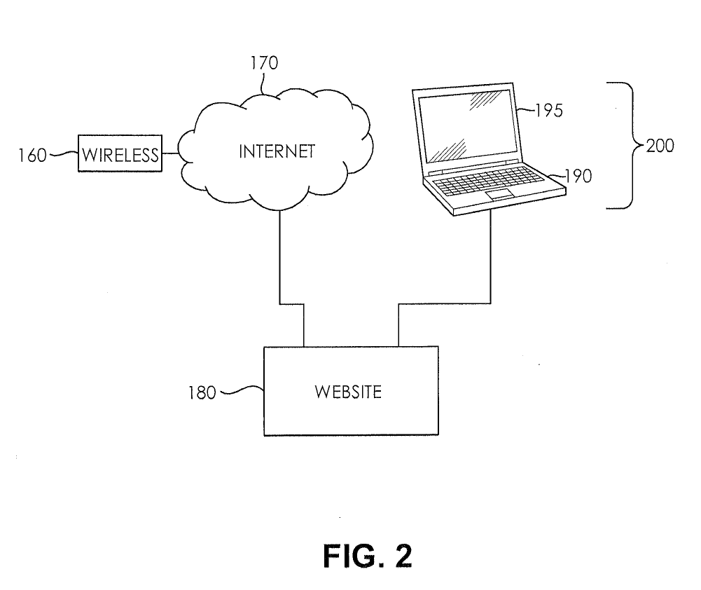

Through the website, a user can at least partially control at least one setting of the camera remotely. The camera settings that may be controlled may include camera focus, camera direction, and camera zoom. The camera may also include a microphone. Referring to FIGS. 1 and 2, the camera 120 can be controlled to take snapshots either locally or remotely (through wireless transceiver or modem 160, which connects to the internet 170, which connects to a website 180. The information on the website may be communicated through the internet to a computer 200 and such information, if graphical may be displayed on monitor or video display 195. A user may enter commands into website 180 through computer 200 through keyboard 190 to cause the camera to take still photos or video.

A video screen may be located remotely from or proximate the video camera or housing in order to display images chosen by a user, for example regarding a deceased person's life and not necessarily those captured by the camera. The speaker may play sounds also so associated. A remote control may be included, which is capable of controlling constituents of the system, for example the camera, the speaker, the video screen. A light source may be included in the system to at least partially illuminate the target object or environment.

The invention further provides a method of transmitting images and sounds from a targeted object or environment to be viewed, the method comprising: (a) providing a camera in the vicinity of a targeted object or environment to be viewed or recorded, (b) operatively connecting a power source, speaker, internet transmission device, and camera, in a housing proximate the targeted object or environment to be viewed or recorded, (c) providing a computer and internet connection, (d) operating the camera to perceive and at least temporarily store images of the targeted object or environment to be viewed or recorded, and optionally its surroundings, (e) transmitting images from the camera through the wireless internet transceiver or modem to the internet, and (f) operating a website in order to display images and/or sounds perceived by the camera to a user.

In the method, the wireless internet transceiver or modem may be integral to the camera. The power source may be selected from the group consisting of a solar panel, a battery, and a mains power source. The power source may be a battery that is a rechargeable battery.

The method may include hosting a virtual store on the website. The website may be housed on a computer proximate the target object or environment or remotely therefrom. In the virtual store, non-tangible and tangible items and services can be purchased. The website has a user interface protected by at least a username and password that allows access to features inaccessible to a user that does not have the username and password.

The website may also house or have access to social networking software to enable users to connect and network through the site. The website allows authenticated users, to communicate with one another, share photos, files, video clips, or audio clips through the network.

In conjunction with a base website, each user may have a customizable web page through which the user can solicit donations for various purposes. One such purpose is for people that cannot afford the burial and services or a deceased loved one. The customizable page that the user makes is can be configured to upload images, videos, and music to give it a special place for the user to make for their loved one. The customizable pages may be created using any major world language.

Once registered the user has the option to link pages among family members to build a family tree.

The method may also include at least partial control of at least one setting of the camera, such as camera focus, camera direction, and camera zoom. The camera may also include a microphone.

A conceptual flowchart of one embodiment of the invention is as follows:

In an embodiment of the invention, a target object 100 (such as for example, a gravestone) is viewed by camera 120 housed in housing 110. Housing 110 also includes solar panel 130, power source 140 and speaker 150. Video screen 155 (not shown) may also be included, either in the vicinity of the camera or housing, or remotely therefrom. Solar panel 130 and/or power source 140 are electrically connected to camera 120 and speaker 150 and video screen 155. Solar panel 130 is powered by sun 135.

Further, camera 120 may include a wireless transceiver or wired modem 160 that allows electrical and data communication between the camera and the internet. Wireless transceiver or wired modem 160 may be physically located on or inside camera 120, and connects to the internet 170, which in turn connects to a website 180. The information on the website may be communicated through the internet to a computer 200 and such information, if graphical may be displayed on monitor or video display 195.

An internet transmission device may include any structure or device capable of transmitting images, sound or other data to or through a computer network, including the internet.

1. A system for perceiving and transmitting images and sounds and sharing information associated with a target object or environment, comprising:
(a) a power source,
(b) a camera,
(c) a speaker,
(d) a computer,
(e) a video screen,
(f) a database,
(g) a website, and
(h) an internet connection
wherein the power source, speaker, at least part of the internet connection and camera, are operatively connected together proximate the target object or environment,
wherein the computer, video screen, database, website and camera are operatively connected to form an operative connection, such that commands entered into the computer are transmitted through the internet connection to effect control of the camera,
wherein the database is capable of storing data perceived by the camera and transmitted to it through at least one of the website and internet connection to the computer.

2. The system of claim 1, further including a remote control capable of controlling at least one of the camera, the speaker and the video screen.

3. The system of claim 1, further including a light source to at least partially illuminate the target object or environment.

4. The system of claim 1 wherein the operative connection among at least the camera, power source and internet connection is a motherboard.

5. The system of claim 1, wherein the internet connection is at least one selected from the group consisting of GSM, WiFi, wireless internet, cellular phone, T1 line, cable internet, satellite and combinations thereof.

6. The system of claim 1, further comprising a housing, wherein the camera, power source and at least part of the internet connection are housed in a housing and operatively connected to one another.

7. The system of claim 1, wherein the website provides access to software that enables a first user to exchange information with at least a second user through at least one of instant messages, message boards, and emails accessible only through the website, wherein the information is at least one of data, photos, images, videos, and audio clips.

8. The system of claim 7, wherein the software includes or accesses point-of-sale software enabling a user to purchase items and/or solicit and receive monetary donations.

9. The system of claim 8, wherein at least one of the website and social networking software is capable of linking at least one of uploaded photos, images, videos and audio clips uploaded by persons to form a virtual family tree.

10. A method of transmitting images and sounds of a target object or environment to a user comprising:
a. providing a camera in the vicinity of a target object or environment,
b. providing and operatively connecting together a power source, speaker, wireless internet transceiver, and camera, in a housing proximate the target object or environment, the power source including (i) a solar panel, and (ii) a least one of a battery and a mains power source,
c. providing an internet connection, to which the camera and a computer are operatively connected,
d. operating the camera by entering commands into the computer which are transmitted through the internet to cause the camera and to perceive and transmit images of the target object or environment,
e. transmitting images from the camera through the internet connection to the internet, and
f. operating a website operatively connected to the internet in order to transmit and display images and/or perceived by the camera to the computer making them visible and/or audible to the user.

11. The method of claim 10, wherein the internet connection is integral to the camera.

12. The method of claim 11, wherein the internet connection is at least one selected from the group consisting of GSM, WiFi, wireless internet, wired modem, cellular phone, T1 line, cable internet, and satellite.

13. The method of claim 12, wherein at least one of the camera, power source and at least part of the internet connection are housed in a housing.

14. The method of claim 12, wherein the website houses a virtual store on which virtual and/or tangible items and/or services can be purchased.

15. The method of claim 12, wherein through the website a user can at least partially control at least one setting of the camera selected from the group consisting of power on, power off, record video, record snapshot, camera focus, camera direction, and camera zoom.

16. The method of claim 12, wherein a remote control device is further provided, and wherein the remote control at least partially controls a camera setting selected from the group consisting of power on, power off, record video, record snapshot, camera focus, camera direction, and camera zoom.

17. A method of presenting at least one of images and sounds of a person comprising:
a. recording at least one of images and sounds of a person,
b. storing the at least one of images and sounds on a server accessible to the internet,
c. providing and operatively connecting together a power source, at least one of a speaker and a video screen, and wireless internet transceiver proximate a gravestone, the power source including (i) a solar panel, and (ii) a least one of a battery and a mains power source,
d. providing a control switch by which a user may control the playback of at least one of a speaker and video screen,
e. providing a website, to which the computer, at least one of a speaker and a video screen and a computer are operatively connected, and
f. operating (1) the control switch or (2) the website to command the server to play back the at least one of images and sounds either on the computer screen or on the at least one of speaker and video screen proximate the gravestone.
